(19) United States
(12) Patent Application Publication
(10) Pub. No.: US 2017/0157992 A1
(43) Pub. Date: Jun. 8, 2017

(54) GROOVE RIDGE FOR REDUCING UNDERTREAD

(71) Applicant: Damon CHRISTENBURY, Fountain Inn, SC (US)

(72) Inventor: Damon CHRISTENBURY, Fountain Inn, SC (US)

(73) Assignees: COMPAGNIE GENERALE DES ETABLISSEMENTS MICHELIN, Clermont-Ferrand (FR); MICHELIN RECHERCHE ET TECHNIQUE S.A., Granges-Paccot (CH)

(21) Appl. No.: 15/321,610

(22) PCT Filed: Jun. 30, 2014
(86) PCT No.: PCT/US2014/044960

§ 371 Date: Dec. 22, 2016

(51) Int. Cl. B60C 11/13

(52) U.S. Cl. CPC B60C 11/1353; B60C 2011/1361

(57) ABSTRACT

The invention includes tire treads, tires incorporating such treads, and methods for forming the same with a reduced undertread thickness. The treads include a length, a thickness, and a width, the width extending transverse to a direction of the tread thickness and a direction of the tread length. The treads further include a void extending into the tread thickness by a depth to a bottom side of the void, the void having a length and opposing sides spaced apart to form a void width. Yet further the treads include a ridge arranged along the bottom side of the void and protruding outward from the bottom side by a ridge height, the ridge also having a ridge length extending at least substantially continuously along the substantial length of the void.

### BACKGROUND OF THE INVENTION

Field of the Invention

This invention relates generally to methods and apparatuses for forming ridges in tread grooves to reduce undertread volume, and for tires and tire treads including ridges in tread grooves.

Description of the Related Art

Tire treads commonly include a variety of void features, such as grooves, extending into the tread thickness. These void features are provided to achieve a desired tire performance. For example, grooves provide void into which water, mud, or other environmental materials may be diverted to better allow the tread surface to engage a surface upon which the tire is operating. Because most tires rely on these void features to obtain desired tire performance characteristics, the usable life of a tread typically does not extend beyond the depth of void features.

Below the void features is an undertread, separating the useable tread from one or more reinforced plies arranged below the tread. It is understood that the one or more reinforced plies may comprise any known reinforced ply. For example, in radial tires, the one or more reinforced plies comprise belt plies, and any ply of reinforced material arranged overtop at least a portion of the belt. Because the reinforced plies provide structural integrity upon which the tire relies for operation, the undertread is useful for protecting the one or more by further separating, by the thickness of the undertread, the one or more plies from the outer side of the tire tread. By doing so, there is a reduced risk that lacerations or punctures entering through the tread will also penetrate the one or more reinforced plies through the undertread.

However, because the undertread is not used during the worn life of the tire, reducing or eliminating the undertread would provide benefits in reducing the cost and weight of a tire. Therefore, there is a need to both reduce or eliminate the undertread while still protecting the one or more plies arranged below the tire tread.

### SUMMARY OF THE INVENTION

The invention includes tire treads, tires, and methods of forming the same. Particular embodiments of the invention comprise a tire tread. The tread includes a length, a thickness extending inward from an outer, ground-engaging side, and a width extending laterally between a pair of opposing lateral sides, the width extending transverse to a direction of the tread thickness and a direction of the tread length. The tread further includes a void extending into the tread thickness by a depth to a bottom side of the void, the void having a length and opposing sides spaced apart to form a void width. Yet further, the tread includes a ridge arranged along the bottom side of the void and protruding outward from the bottom side by a ridge height, the ridge also having a ridge length extending at least substantially continuously along the substantial length of the void.

Further embodiments of the invention comprise a method of reducing undertread thickness of a tire. One step of such methods includes providing a tire, the tire having a tread arranged over one or more reinforce plies. The tire tread includes a length, a thickness extending inward from an outer, ground-engaging side, a width extending laterally between a pair of opposing lateral sides, the width extending transverse to a direction of the tread thickness and a direction of the tread length. The tread further includes a void extending into the tread thickness by a depth to a bottom side of the void, the void having a length and opposing sides spaced apart to form a void width. The tread yet further includes a ridge arranged along the bottom side of the void and protruding outward from the bottom side by a ridge height, the ridge also having a ridge length extending at least substantially continuously along the substantial length of the void. Another step of such methods includes arranging the tread relative a top, first ply of the one or more reinforced plies such that an undertread thickness equaling a distance extending from a bottom of the void to the top, first ply is reduced by at least a portion of the ridge height.

The foregoing and other objects, features, and advantages of the invention will be apparent from the following more detailed descriptions of particular embodiments of the invention, as illustrated in the accompanying drawings wherein like reference numbers represent like parts of the invention.

### DETAILED DESCRIPTION OF THE DRAWINGS

FIG. 1 is a cross-sectional view of a prior art tire, taken along a plane extending in both a radial and lateral direction of the tire.

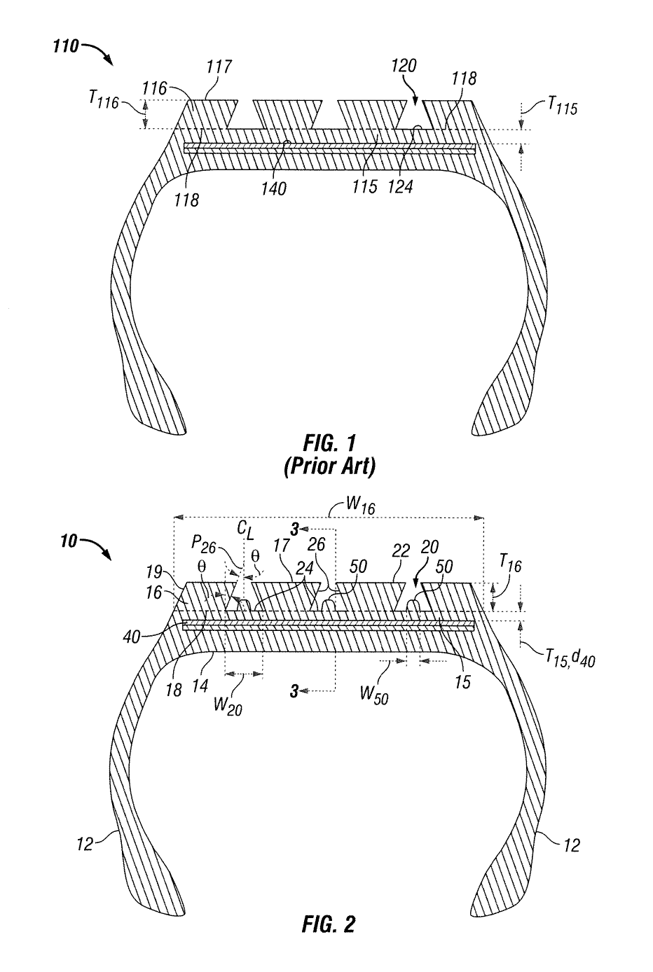

FIG. 2 is a cross-sectional view of a tire, in accordance with an embodiment of the invention, taken along a plane extending in both a radial and lateral direction of the tire.

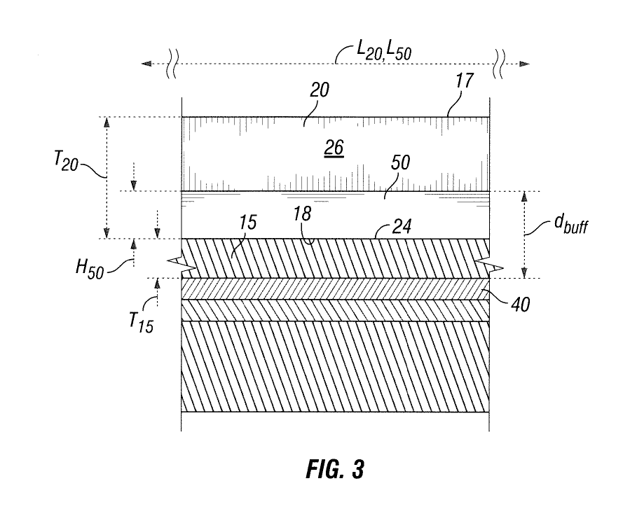

FIG. 3 is a cross-sectional view of the tire shown in FIG. 2, taken along section 3-3.

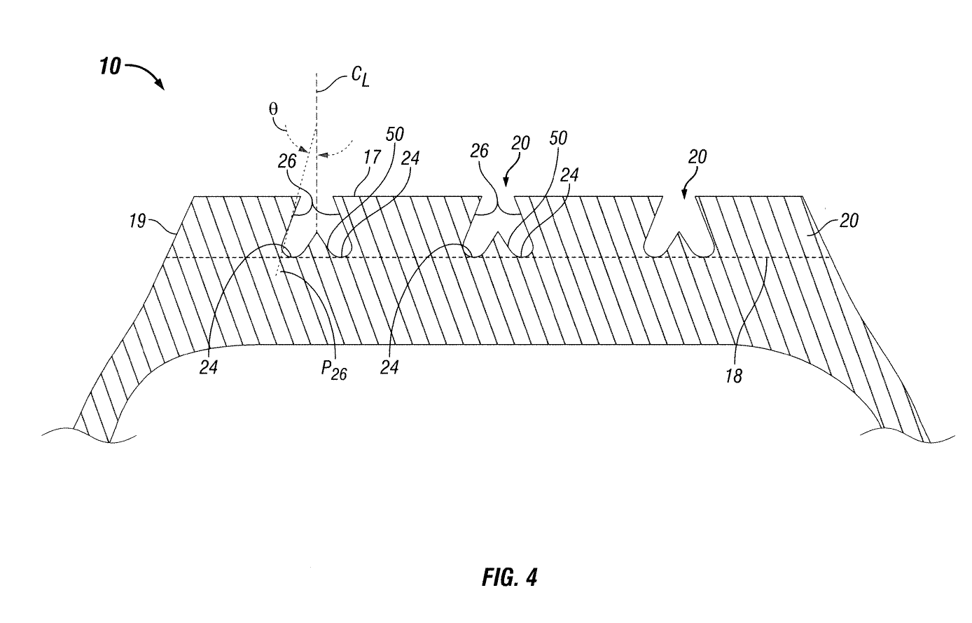

FIG. 4 is a cross-sectional view of a tire, taken along a plane extending in both a radial and lateral direction of the tire, in accordance with another embodiment of the invention.

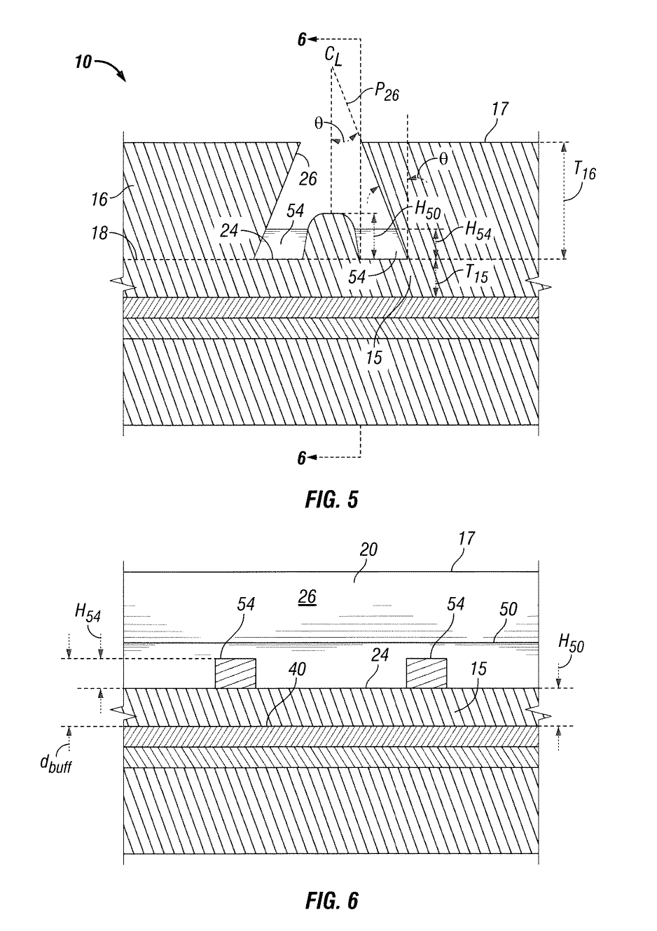

FIG. 5 is a partial cross-sectional view of a tire, taken along a plane extending in both a radial and lateral direction of the tire, in accordance with another embodiment of the invention.

FIG. 6 is a cross-sectional view of the tire shown in FIG. 5, taken along section 5-5.

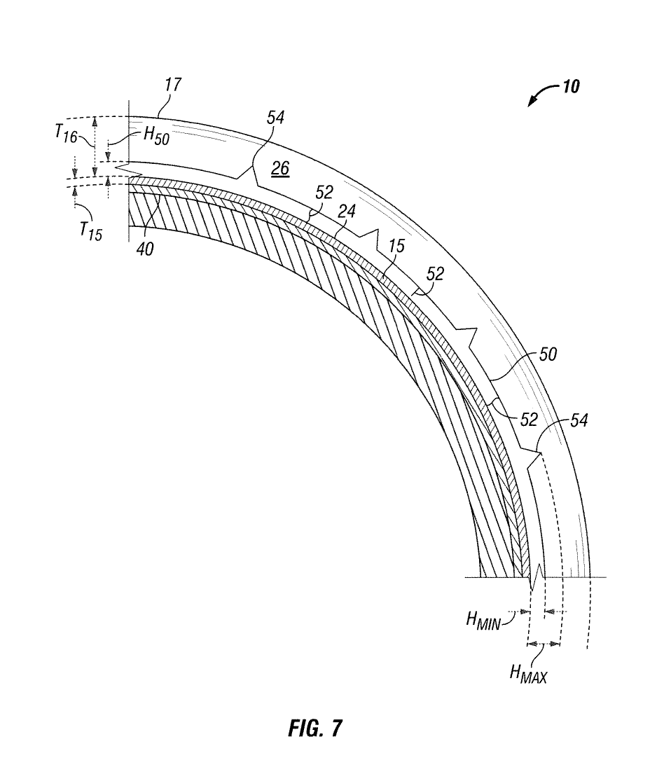

FIG. 7 is a cross-sectional view of a tire, taken along a plane extending in both a radial and circumferential direction of the tire, in accordance with another embodiment of the invention.

### DETAILED DESCRIPTION OF PARTICULAR EMBODIMENTS

Particular embodiments of the invention provide tire treads including ridges arranged along a void bottom for protecting one or more reinforced plies, which facilitates use of a reduced-thickness undertread or exclusion of any undertread. By reducing the thickness of the undertread or eliminating the undertread altogether, weight and costs savings may be appreciated. The invention further includes tires having any such tread.

In the prior art, an undertread is arranged below void features to separate the useable tread and one or more reinforced plies of material, such as one or more belt plies, for example. With reference to FIG. 1, a prior art tire 110 is shown. The tire includes a tread 116 having a thickness T₁₁₆ extending in a radial direction from a ground-engaging side 117 of the tread to a bottom side 118, which is generally arranged at a depth that coincides with a bottom of the deepest void feature. The tread includes a plurality of void features 120 comprising grooves. The void features 120 have a depth extending within the tread thickness from the ground-engaging side 117. Each groove 120 comprising a void in tread 116 also has a depth d₁₂₀ extending to a groove bottom 124 (more generally referred to as a “void bottom”).

In the prior art tire, an undertread 115 is arranged below the tread and void features 120. The undertread has a thickness T₁₁₅ extending in a direction of a tread thickness, which may be herein used interchangeably with “a radial direction” when the tread is mounted on a tire. As noted above, the undertread 115 is arranged between the tread 116 and the one or more belt plies 140. In the prior art, undertread thickness T₁₁₅ is usually equal to or greater than 2 millimeters (mm), which also represents a buffer distance. The undertread thickness is selected to provide a desired buffer distance between a void bottom and the first, top ply of the one or more reinforced plies, so to better insulate the one or more plies from damage that may occur when debris or other objects penetrate the tire through the void bottom. The invention disclosed herein, according to various exemplary embodiments, provides for a reduced-thickness undertread, or eliminates the undertread, by arranging a ridge along a void bottom to provide a desired buffer distance between the top of the ridge and the first, top ply of the one or more plies.

Accordingly, particular embodiments of the invention include a method of reducing undertread thickness of a tire. One step of such methods includes providing a tire, the tire having a tread arranged over one or more reinforce plies. The reinforced plies may comprise any known ply, such as a ply of elastomeric material reinforced with unwound or wound cord or fabric, for example. In particular instances, one of ordinary skill in the art would understand one or more reinforced plies to comprise one or more tire belt plies in a radial tire or one or more biased plies in a biased tire. In the step of providing a tire, the tread includes a length, a thickness extending inward from an outer, ground-engaging side, a width extending laterally between a pair of opposing lateral sides, the width extending transverse to a direction of the tread thickness and a direction of the tread length. The tread further includes a void extending into the tread thickness by a depth to a bottom side of the void, the void having a length and opposing sides spaced apart to form a void width. The tread yet further includes a ridge arranged along the bottom side of the void and protruding outward from the bottom side by a ridge height, the ridge also having a ridge length extending at least substantially continuously along the substantial length of the void.

Another step of such methods includes arranging the tread relative a top, first ply of the one or more reinforced plies such that an undertread thickness equaling a distance extending from a bottom of the void to the top, first ply is reduced by at least a portion of the ridge height to provide a desired buffer distance extending from the top, first ply and comprising at least a portion of the ridge. In other variations, the desired buffer distance extends from the top, first ply to a top of the ridge.

By employing these methods, in accordance with any embodiment, a prior art undertread thickness is reduced or even eliminated, at least along certain portions of the tire or along the full length and width of the tire tread, when compared to the prior art undertread thickness, where the claimed ridge is not present. The tread employed by these methods may comprise any tread discussed herein, and the resulting arrangement of the ridge to the first, top ply may also be as otherwise discussed herein according to other embodiments. For example, in certain exemplary embodiments, the ridge height is equal to or greater than 1 millimeter. By further example, in certain exemplary embodiments, a top of the ridge is spaced substantially 2.0 millimeters or more above the top, first ply. By yet further example, in further exemplary embodiments, the distance between the void bottom and the top, first ply is substantially equal to 1.0 mm to zero. Other exemplary embodiments are described below.

As stated above, the invention described herein arranges a ridge along a bottom of a void, while reducing or eliminating the undertread. Treads and tires formed according to these methods, as well as those methods further described below, will now be discussed in association with certain embodiments described in the figures.

In accordance an exemplary embodiment of the invention, with reference to FIG. 2, a tire 10 is shown. The tire 10 is a pneumatic tire including a pair of sidewalls 12 each extending radially outward from a rotational axis of the tire to a central portion 14 of the tire 10. The central portion 14 of the tire includes a tread 16 having a thickness T₁₆ extending in a radial direction from an outer, ground-engaging side 17 of the tread to a bottom side 18, which is generally arranged at a depth that coincides with a bottom of the deepest void feature 20. Tread 16 has a length, which when attached to the tire, extends annularly around the tire relative a rotational axis. The tread also has a width W₁₆ extending in a lateral direction between the pair of opposing, lateral sides or side edges 19 of the tread. The lateral or widthwise direction is perpendicular to both a direction of the tread thickness and a direction of the tread length.

The tread further includes a plurality of void features, which may comprise grooves, which may be lateral or longitudinal grooves. In the embodiment of FIG. 2, tread 16 includes a plurality of void features 20 comprising longitudinal grooves. Generally, void features have a length extending in a direction transverse to a direction of the tread thickness and at least partially in a direction of the tread length (in the embodiment shown) or at least partially in a direction of the tread width (in other embodiments). Each void feature 20 has a depth D₂₀ extending within the tread thickness T₁₆ from a void bottom 24, which is more specifically a groove bottom in the embodiment shown. While the void feature 20 can be formed originally to extend into the tread thickness T₁₆ from the ground-engaging side 17, such as is exemplarily shown in the embodiment of FIG. 2, it is appreciated that the void feature may be originally spaced-apart from the outer, ground-engaging side in a new tread, where a thickness of the tread must be worn or otherwise removed to expose the submerged void during the life of the tire. Void bottom 24 is the portion of void feature 20 arranged closest to (or coincident with) tread bottom side 18, or, stated differently, furthest from the outer, ground-engaging side 17 of the tread. It is appreciated that, without considering a ridge arranged along the bottom side, as discussed herein, the void bottom may extend in widthwise direction along any profile or path, whether linear or non-linear.

With reference to the exemplary embodiment in FIG. 2, void feature 20 can be described as having a pair of opposing sides 26 spaced apart to define a width W₂₀ of the void feature. It is understood that the opposing sides may extend in any direction, whether extending along a linear or non-linear path, to form a void having any desired cross-sectional shape. For example, each of the opposing sides may extend substantially in a direction of the tread thickness, or even extend away from a widthwise centerline of the void as the void extends outwardly toward the outer, ground-engaging side from the void bottom, so to create a void width that narrows as the void extends toward the void bottom. In other embodiments, as exemplarily shown in FIG. 2, the void width W₂₀ narrows as the void extends outwardly toward the outer, ground-engaging side 17 from the void bottom 24, so to create a void width that widens as the void extends from a top 22 of the void 20 toward the void bottom. To achieve this, at least one of the opposing sides 26 of the void extend towards a widthwise centerline CL of the void 20 as the void extends outwardly toward the outer, ground-engaging side 17 from the void bottom 24. This inward widening of the void is beneficial to further improve protection of the void bottom, when reducing or eliminating the undertread as discussed herein. In particular, by maintaining a void opening along the outer, ground-engaging side that is narrower in width than a width of the void bottom, the possibility of foreign objects entering the void that may puncture or lacerate the void bottom is reduced. Further, by providing this inward-widening of the void, a desired opening width is able to be maintained while widening the void bottom as necessary to provide a ridge as described herein. In an exemplary embodiment, for a void having a width that widens with increasing void depth, the void width W₂₀ widens from a width substantially equal to 2 millimeters (mm) to a width substantially equal to or greater than 6 mm. In another variation, the void width W₂₀ widens from a width substantially equal to 2 millimeters (mm) to a width substantially equal to 7 to 8 mm Of course, wider and smaller widths are contemplated, as any tread may be designed to achieve any desired design criteria, such to obtain desired performance results and/or aesthetic preferences. In particular embodiments, the width of a ridge (W₅₀) is equal to or greater than the narrowest width of the void width (W₂₀), whereby the ridge and the narrowest width of the void are aligned in a direction of the tread thickness, such as along the widthwise centerline of the void. Such embodiments provide for more efficient use of the ridge as a buffer against debris or other objects entering the void. In particular embodiments, at or near the void bottom the void width substantially equal to or greater than 6 mm, or 7 to 8 mm, to provide sufficient area for receiving a ridge, as discussed herein. It is appreciated that differently sized widths and rates of widening may be employed as desired in other variations. It is also appreciated that the opposing sides of the void may extend in a depthwise direction along any linear or non-linear path.

It is appreciated that narrowing of the void width with increasing depth may occur from the void top to the void bottom, along an intermediate depth between the void top and void bottom, or any combination thereof. In other words, it is appreciated that the void width may effectively widen with increasing depth over a majority of the depth or along a substantial portion of the depth, even though the void width at or near the void top, at or near the void bottom, or at any intermediate location there between may locally narrow or remain constant. This effective widening with increasing void depth may also be represented by an effective inclination angle by which each of the opposing sides extends along an effective linear path relative to the depthwise direction of the tread, which not only takes into account any local narrowing of the void width as the void depth increases or any constant width along the void depth, it also takes into account any non-linearity of the path along each side extends with increasing depth. In an exemplary embodiment, shown in FIG. 4, having sides 26 extending along non-linear paths, this effective inclination angle θ measures the angular bias of an effective side-extension path P₂₆ relative to the widthwise centerline CL of the void, where the effective side-extension path is a linear path obtained by averaging the direction along with a respective side extends over the full depth of the void. For example, in different instances, the effective inclination angle θ is substantially equal to 4 to 8 degrees, 12 to 15 degrees, or any other angle desired.

In particular embodiments, an undertread is arranged below the tread, extending generally from the bottom of the deepest void feature in the tread to one or more reinforced plies arranged within the tire. Stated differently, the undertread is arranged between the tread and the one or more reinforced plies. In other embodiments, no undertread is present. The reason for these different embodiments, is through the addition of substantially continuous ridges being arranged to protrude from the groove bottom. In more particular variations, the void bottom includes a substantially continuous ridge or protrusion, arranged intermediately between the opposing sides defining a width of the void. With reference to the embodiments in FIGS. 2 and 3, a reduced thickness undertread 15 is shown arranged between the tread 16 and a top, first ply 40. A ridge 50 is arranged along a bottom side 24 of the void, and extends outwardly from the bottom side by a height H₅₀. The top, first ply 40 (also referred to more simply as a first ply) of the one or more reinforced plies is shown, offset from a groove bottom 24 by a distance d₄₀. This offset distance d₄₀ also represents the thickness of the reduced-thickness T₁₅. Accordingly, a desired buffer distance d_{buff} between the top of a ridge and the first ply is equal to a sum of the offset distance and the ridge height. Otherwise, in embodiments where the offset distance d₄₀ is zero, that is where the first ply is arranged at the groove bottom, the ridge height H₅₀ is at least equal to the desired buffer distance d_{buff}.

As noted above, the invention includes arranging a ridge along the void bottom, intermediately between the opposing sides defining a width of the void. With reference to the exemplary embodiment in FIGS. 2 and 3, a ridge 50 is shown extending or protruding outwardly from the void bottom 24 by a height H₅₀. By protruding outwardly as such, the ridge extends in a direction of the tread thickness T₁₆ towards the outer, ground-engaging side 17 of the tread 16. The ridge can be said to form a bottom of the void bottom, or it can be said to be separate yet connected to the void bottom. This way, the ridge may be formed by any manner known to one of ordinary skill. For example, the ridge may be molded with the void into the tread, or may otherwise may be formed after tread is originally formed, such as by cutting the ridge into the tread or by affixing the ridge to the originally formed tread. In any event, it is appreciated that formation of a ridge may be performed by any manual or automated process or machine, of which may contain a processor and memory storage device configured to store instructions for performing the method steps discussed and contemplated herein.

The ridge also has a length to provide a buffer along a substantial length of a void. With reference to an exemplary embodiment in FIG. 7, ridge 50 has a length L₅₀ extending substantially continuously along a length L₂₀ of the void. In particular embodiments, the ridge extends substantially continuously along a substantial length of the void. “Substantially continuously” connotes the ridge generally extends continuously along its length, except that, in certain instances, the otherwise continuous ridge includes one or more narrow voids having a width of 0.5 mm or less, whereby any anticipated debris or objects are unable to substantially penetrate or enter any such narrow void. For any such substantially continuous ridge, it is understood that the narrow void may extend partially or fully across a width of the ridge and/or partially or fully into a depth of the ridge. In such instances, it can be said that the substantially continuous ridge comprises an array of a plurality of narrowly spaced-apart ridges. A substantially continuous ridge is continuous along the full length of the ridge, which may extend along a partial length or a full or substantially full length of a void. While the narrow void may comprise a narrow groove, it may also comprise a laceration or slit, which therefore may comprise a sipe. A sipe is a narrow groove or a slit or laceration, such that when the sipe is in a tire footprint, opposing sides of the sipe contact. A narrow groove may remain open, albeit by a sufficiently small amount to provide a narrow opening to resist the entry of debris or any other desired object. In an exemplary embodiment, with reference to FIG. 7, a ridge is shown to extend into a void from a bottom side of the void. Ridge 50 is shown to have a length L₅₀ extending in a direction of the void length L₂₀, where the ridge extends substantially continuously along its length with narrow voids or sipes 52 spaced apart along the ridge length and extending partially or fully through the height H₅₀ of the ridge. It is appreciated that the ridge length may extend lengthwise along any linear or non-linear path along the void bottom. For example, a non-linear path may comprise an undulating path, where the path alternates between different widthwise directions of the void, which may comprise a smoothly-contoured winding alternation or a linearly-stepped alteration, such as a saw-tooth or stepped-function type path.

By arranging such a ridge along the void bottom, the ridge can impede the penetration of debris or other objects toward the one or more reinforced plies arranged below the tread. As noted above, a buffer distance is often desired between the groove bottom and the one or more reinforced plies. In the prior art, with reference to FIG. 1 for exemplary purposes, this buffer distance d_{buff} is measured from a void bottom 124 to the first, top ply 140 of the one or more reinforced plies in the prior art, where the buffer distance is generally equal to the thickness of the undertread 115. By adding a ridge as discussed herein to the void bottom, with reference to the exemplary embodiment of FIGS. 2 and 3, the height H₅₀ of ridge 50 forms at least a portion of the buffer arranged above the one or more reinforced plies, where the buffer has a thickness equal to the buffer distance d_{buff}. As such, a buffer having a desired thickness equal to the buffer distance is measured from a top of the ridge to the first, top ply 40 of the one or more reinforced plies. By including the ridge 50 as a portion of the buffer, the undertread 15 may be reduced or minimized, and even eliminated with respect to the prior art. In embodiments where the undertread is eliminated, the first, top ply is arranged to engage the tread and the height H₅₀ of the ridge is equal to the desired buffer distance d_{buff}. By way of example, in particular embodiments, where it is desirous to have a buffer distance of 2 mm, in certain instances, the ridge height is at least 2 mm, such that no undertread is present. In other variations, however, a reduced thickness undertread is provided, such as where the ridge cannot have a height equal to the buffer distance. This may arise as a design choice, such as when not wanting to consume any more of the volumetric void to maintain a minimum void volume necessary to evacuate a desired amount of water, snow, or mud from a tire footprint. In certain instances, a minimally thick undertread may be present, such as due to manufacturing requirements or tolerances. In any event, a reduced undertread thickness is equal to 1 mm or less, substantially 0.5 to 1.0 mm, or 0.5 mm or less.

To achieve desirous buffering characteristics, the ridge is arranged intermediately between the opposing sides of the void, which define a width of the void. In particular instances, when arranged intermediately, the ridge is arranged between and spaced-apart from each of the opposing void sides. This is shown by example in FIG. 2, where the ridge 50 is arranged intermediately between opposing sides 26, where the ridge is arranged between and spaced-apart from each of the opposing sides. While not necessary to be an intermediately arranged ridge, in FIG. 2, ridge 50 is also centered along the widthwise centerline CL of the void 20, thereby exemplifying embodiments where an intermediately arranged ridge is centered along the void width.

It is appreciated that the ridge may comprise any shaped protrusion. For example, along a cross-section taken along a plane extending in both a direction of the ridge width (W₅₀) and in a direction of the ridge height (H₅₀), the plane being arranged perpendicular to a direction of the ridge length (L₅₀). For example, in the variation shown in FIG. 2, the cross-sectional shape of ridge 50 is generally semi-circular, while in the variation shown in FIG. 4, the cross-sectional shape of ridge 50 is more triangular in shape, resulting in a teardrop-like cross section.

It is appreciated that the height of a ridge may remain constant or vary over the length of the ridge. For example, the height of the ridge may remain constant, such as to consistently provide a desired buffer distance. By further example, the ridge height may vary for aesthetic purposes or when it is desirous to arrange certain features along or atop the ridge, so long as a minimum ridge height is provided to provide a desired buffer distance. In the exemplary embodiment of FIG. 7, a variable-height ridge is shown, where the height H₅₀ varies from a minimum height Hₘᵢₙ, which is configured to provide a desired buff distance, to a maximum height Hₘₐₓ. At the maximum height Hₘₐₓ, protruding features 54 are provided, which may operate as stone ejectors, for example. It is appreciated that the variable height may extend in a direction of the ridge length along any non-linear path. In other variations, where the ridge has a height greater than is needed to provide a desired buffer distance, in lieu, or in addition to protrusions, the ridge may include voids or recesses.

FIGS. 5 and 6 illustrate another exemplary embodiment wherein a protruding feature 54 comprising a wear indicator is arranged along a ridge 50. Wear indicators allow an observer to better ascertain whether a tire tread is reaching the end of its intended life. While it is appreciated that wear indicators may be sized as desired to identify how much useable tread remains on the tread, commonly, wear indicators have a height H₅₄ commonly equal to 1 to 2 mm, and in more specific instances, approximately 1.6 mm Therefore, it is appreciated that the wear indicators may have a height H₅₄ extending above or below a height H₅₀ of the ridge. For example, in instances when ridge 50 has a height H₅₀ of 2 mm or more and the height H₅₄ of the wear indicators is equal to 1.6 mm, the wear indicators 54 extend below the ridge. It is appreciated that wear indicators 54 may comprise any desired shape and may extend from one or both sides of a ridge 50, whether staggered or aligned in a lengthwise direction of the ridge, and which may be provided by any regulatory guidelines.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the invention. Ranges that are described as being “between a and b” are inclusive of the values for “a” and “b” unless otherwise specified.

While this invention has been described with reference to particular embodiments thereof, it shall be understood that such description is by way of illustration only and should not be construed as limiting the scope of the claimed invention. Accordingly, the scope and content of the invention are to be defined only by the terms of the following claims. Furthermore, it is understood that the features of any specific embodiment discussed herein may be combined with one or more features of any one or more embodiments otherwise discussed or contemplated herein unless otherwise stated.

1. A tire tread comprising:
a length, a thickness extending inward from an outer, ground-engaging side, and a width extending laterally between a pair of opposing lateral sides, the width extending transverse to a direction of the tread thickness and a direction of the tread length;
a void extending into the tread thickness by a depth to a bottom side of the void, the void having a length and opposing sides spaced apart to form a void width;
a ridge arranged along the bottom side of the void and protruding outward from the bottom side by a ridge height, the ridge also having a ridge length extending at least substantially continuously along the substantial length of the void; and,
an undertread thickness equaling a distance extending from the bottom side of the void to a bottom side of the tread, the undertread thickness having a thickness substantially equal to 1 mm or less.

2. The tire tread of claim 1, where the tread forms a portion of a tire, where a top, first ply of one or more reinforced plies is below the tread, the top, first ply being arranged a buffer distance from a top of the ridge, the undertread thickness equaling a distance extending from the bottom side of the void to the top, first ply.

3. The tire tread of claim 2, where the height of the ridge is at least equal to the buffer distance.

4. The tire tread of claim 1, where the void width increases in the direction of the tread thickness from the bottom side of the void and toward the outer, ground-engaging side of the tread.

5. The tire tread of claim 1, where the bottom side of the void has a width equal to or greater than 6 mm.

6. The tire tread of claim 1, where the ridge is arranged intermediately between the opposing sides of the void.

7. The tire tread of claim 6, where the ridge is substantially centered between the opposing sides of the void.

8. The tire tread of claim 1, where the depth of the void extends into the tread thickness from the outer, ground-engaging side.

9. The tire tread of claim 1, where the ridge length extends continuously along the length of the void.

10. The tire tread of claim 1, where the void is a groove.

11. The tire tread of claim 2, where the first, top ply is arranged to engage the tread.

12. (canceled)

13. The tire tread of claim 1, the undertread thickness having a reduced-thickness substantially equal to 0.5 mm or less.

14. The tire tread of claim 1, where the ridge height varies along the length of the ridge.

15. The tire tread of claim 1, where the ridge includes a tread feature comprising a recess or a protrusion.

16. The tire tread of claim 15, where the protrusion comprises a stone ejector or a wear indicator.

17. The tire tread of claim 1, where a maximum width of any portion of the ridge is at least substantially equal to a narrowest portion of the void width.

18. A method of reducing an undertread thickness of a tire, the method comprising:
providing a tire, the tire having a tread arranged over one or more reinforce plies, the tread having:
a length, a thickness extending inward from an outer, ground-engaging side, a width extending laterally between a pair of opposing lateral sides, the width extending transverse to a direction of the tread thickness and a direction of the tread length;
a void extending into the tread thickness by a depth to a bottom side of the void, the void having a length and opposing sides spaced apart to form a void width; and,
a ridge arranged along the bottom side of the void and protruding outward from the bottom side by a ridge height, the ridge also having a ridge length extending at least substantially continuously along the substantial length of the void;
arranging the tread relative a top, first ply of the one or more reinforced plies such that an undertread thickness equaling a distance extending from the bottom side of the void to the top, first ply is reduced by at least a portion of the ridge height to provide a desired buffer distance extending from the top, first ply and comprising at least the portion of the ridge.

19. The method of claim 18, whereby the ridge height is equal to or greater than 1 millimeter.

20. The method of claim 18, whereby a top of the ridge is spaced substantially 2.0 millimeters or more above the top, first ply.

21. The method of claim 18, the distance between the bottom side of the void and the top, first ply is substantially equal to 1.0 mm to zero mm.
